(19) United States
(12) Patent Application Publication
(10) Pub. No.: US 2012/0110856 A1
(43) Pub. Date: May 10, 2012

(54) ELECTRIC MOTOR FOR AN ELECTRIC APPLIANCE

(76) Inventors: Frank Kressmann, Eschborn (DE); Uwe Schober, Glashuetten (DE); Alexander Doll, Kronberg/Taunus (DE)

(21) Appl. No.: 13/311,790

(22) Filed: Dec. 6, 2011

Related U.S. Application Data
(63) Continuation-in-part of application No. PCT/IB2010/052594, filed on Jun. 10, 2010.

(30) Foreign Application Priority Data
Jun. 12, 2009 (EP) 09007760.0

(51) Int. Cl. B26B 19/28; A46B 13/02; H02K 57/00

(52) U.S. Cl. 30/45; 310/12.14; 15/22.1

(57) ABSTRACT

An electric motor for an electric appliance having a rotor, a stator, and a coil for the generation of a magnetic field. The motor has a first magnet arrangement having a first permanent magnet which, by interaction with a magnetic field generated using the coil, generates a force for the excitation of a rotary movement of the rotor. A second magnet arrangement may also be provided which has at least one second permanent magnet is arranged such that a translatory oscillatory movement of the rotor is effected by the Lorentz force acting in the field of the second permanent magnet on the conductors of the coil through which current flows.

### CROSS REFERENCE TO RELATED APPLICATION

This application is a continuation-in-part application of prior copending International Application No. PCT/IB2010/052594, filed Jun. 10, 2010, designating the United States.

### FIELD OF THE INVENTION

The invention relates to an electric motor. The invention further relates to an electric appliance having such a motor and to a method for operating an electric motor.

### BACKGROUND OF THE INVENTION

Electric motors are known which can generate a rotary and a linear oscillatory movement and are used, for example, for electric toothbrushes.

Known motors provide for this purpose a DC motor and a subsequent translation of the rotary movement into an additional linear movement with the help of a transmission or the generation of the linear movement in a first drive unit and the generation of the rotary movement in a second drive unit.

An electric motor described in WO 2005/062445 has two oscillatory motor components and a magnet arrangement with a plurality of permanent magnets. A coil generates a magnetic field which is provided for the generation of a force for the excitation of a linear oscillatory movement of an oscillatory component by interaction with the magnet arrangement. The interaction of the magnetic field generated by the coil and the magnet arrangement additionally generates a torque for the generation of a rotary oscillatory movement of a second oscillatory motor component.

It would be advantageous to provide a compact and cost-effective electric motor of simple construction for appliances and a method for the operation of such an electric motor.

### SUMMARY OF THE INVENTION

An electric motor for an electric appliance is provided herein. In one embodiment, the electric motor includes a rotor having an axis of rotation, a stator, a coil having conductors, a first magnet arrangement having at least one first permanent magnet which generates a force for the excitation of a rotary movement of the rotor about an axis of rotation by interaction with a magnetic field generated using the coil, and a second magnet arrangement which includes at least one second permanent magnet which is arranged such that a translatory oscillatory movement of the rotor is effected by a Lorentz force acting in a first field of the second permanent magnet on the conductors of the coil through which current flows.

Another embodiment of an electric motor for an electric appliance is also provided. The electric motor includes a rotor, a stator, a coil having conductors, and a first magnet arrangement having at least one first permanent magnet which, by interaction with a magnetic field generated using the coil, generates a force for the excitation of a rotary movement of the rotor about an axis of rotation, wherein the first magnet arrangement is arranged such that a translatory oscillatory movement of the rotor is effected by a Lorentz force acting in the magnetic field of the at least one first permanent magnet on the conductors of the coil through which a current flows.

In addition, a method of providing a translator oscillatory movement in an electric motor is provided. The electric motor has a rotor, a stator, a coil including conductors and a magnetic arrangement including at least one permanent magnet, the method including the steps of generating a magnetic field with the coil, generating a force to rotate the rotor by interacting the at least one permanent magnet with the magnetic field, and generating a Lorentz force on the conductors of the coil through which current flows to provide a translator oscillatory movement in the rotor.

### BRIEF DESCRIPTION OF THE DRAWINGS

The invention will be explained with reference to the enclosed schematic Figures in detail which show embodiments in accordance with the invention by way of example. There are shown:

FIG. 1 is a perspective schematic view of an electric motor in accordance with the invention in a partly transparent representation;

FIG. 2 is a sectional view in the Y-Z plane indicated in FIG. 1;

FIG. 3 is a perspective schematic view of another embodiment in accordance with the invention in a partly transparent representation;

FIG. 4 is a perspective schematic view of a further embodiment in accordance with the invention in a partly transparent representation;

FIG. 5 is a cross-sectional view in the X-Y plane indicated in FIG. 4 with indicated magnetic field lines; and

FIG. 6 is a perspective schematic view of yet a further embodiment in accordance with the invention in a partly transparent representation.

### DETAILED DESCRIPTION OF THE INVENTION

An electric motor in accordance with the invention for an electric appliance has a rotor and a stator and a coil for the generation of a magnetic field. A first magnet arrangement has at least one permanent magnet which, by interaction with a magnetic field generated with the coil, generates a force for the excitation of a rotary movement of the rotor. An electric motor in accordance with the invention may include a second magnet arrangement which comprises at least one second permanent magnet which is arranged such that a translatory oscillatory movement of the rotor is effected by the Lorentz force acting in the field of the second permanent magnet on the conductors of the coil through which current flows.

Two different physical principles are combined with the help of the electric motor in accordance with the invention in order to generate the rotary movement, on the one hand, and the translatory movement, on the other hand. The rotary movement is generated using a first magnet arrangement and a coil. An iron core with a coil in which a magnetic flux is generated with the help of the coil can, for example, be provided as a stator in the center of the drive. Permanent magnets can be arranged in a surrounding manner align in accordance with the flux direction so that a rotary movement of the surrounding rotor takes place.

A second magnet arrangement may be provided which has at least one permanent magnet which generates a magnetic Lorentz force on the conductors of the coil through which current flows. With a fixed coil, this means a relative movement of the at least one second permanent magnet in the translatory direction. A compact, simple and cost-effective embodiment for an electric motor for an appliance is possible by the utilization of the Lorentz force of a magnet arrangement on the conductors of the coil through which current flows. The individual parts for the construction of the drive may be reduced.

It is generally possible to couple the relative translatory movement of the at least one second permanent magnet and the rotary movement of the rotor to obtain a coupled rotary and linear movement. It is, however, particularly simple if the second permanent magnet moves together with the rotor, in particular if it is connected to it. The rotary movement of the rotor and the linear movement of the at least second permanent magnet are then automatically combined to a coupled movement.

The at least one second permanent magnet can be arranged such that it generates a field which would be aligned substantially parallel to the axis of rotation of the rotor if no other magnetic field influencing fields are present. This can be achieved in a simple manner if the at least one second permanent magnet is disposed above or beneath the coil in symmetrical alignment with the axis of rotation of the rotor. With such an arrangement, provision can, for example, be made that a second permanent magnet is provided both above and beneath the coil to double the desired effect. The magnetic flux which is generated by such an arrangement of the at least one second permanent magnet in particular acts on the conductor regions of the coil aligned perpendicular to the axis of rotation.

Another embodiment provides that the at least one second permanent magnet is arranged such that it would generate a field substantially radially to the axis of rotation of the rotor if no other magnet field-influencing elements were present. The magnetic flux which is generated by this arrangement of the at least one second permanent magnet in particular acts on the conductor regions of the coil aligned parallel to the axis of rotation.

A particularly space-saving arrangement is possible when the at least one permanent magnet of the second magnet arrangement is arranged between the permanent magnets of the first magnet arrangement.

The described embodiments can also be combined with one another, with a second magnet arrangement therefore being provided which has at least one second permanent magnet which generates a field which is aligned substantially radially to the axis of rotation of the rotor and has at least one additional permanent magnet whose field is aligned substantially parallel to the axis of rotation of the rotor. In this manner, the strength of the Lorentz force, and thus, for example, the amplitude of the translatory oscillatory movement, can be set very flexibly.

With a suitable arrangement of the individual segments of the permanent magnets of the first and second magnet arrangements, it is also possible that at least a part of the second magnet arrangement is in one piece with a part of the first magnet arrangement.

Another electric motor in accordance with the invention is provided wherein the first magnet arrangement is arranged such that a translatory movement is effected in the field of the at least one first permanent magnet by the Lorentz force on the conductors of the coil through which current flows. The first magnet arrangement is, for example, made correspondingly asymmetrically so that in addition to the magnetic flux the permanent magnets of the first magnet arrangement generate for the generation of the rotary movement, field components are present which exert a Lorentz force onto the conductors of the coil through which current flows. Such an arrangement can be manufactured in a particularly compact and simple manner.

Electric motors in accordance with the invention can be designed to carry out a translatory oscillatory movement and a continuous rotary movement. The invention is, however, particularly expedient when the rotary movement also is an oscillatory movement.

When the rotary oscillatory movement and the translatory oscillatory movement have different resonant frequencies, the individual oscillatory movements can also be controlled separately by feeding in current of correspondingly selected frequencies. Feeding in mixed frequencies effects a correspondingly distributed rotary or translatory oscillatory movement.

It is generally possible that an optionally present soft magnetic core (of iron, for example) of the coil is, for example, rotatably supported and the permanent magnets of the electric motor are still. The core then forms the rotor which also carries out the translatory oscillatory movement. In certain embodiments, however, if the core of the coil may be part of the stator of the electric motor and the rotor may include the first magnet arrangement. In this respect, an arrangement is particularly compact in which the coil is arranged inside the first magnet arrangement.

With the electric motors in accordance with the invention, the arrangement may be selected such that the translatory movement is perpendicular to the axis of rotation.

The electric motor in accordance with the invention is particularly suitable for the drive of small electric appliances such as electric toothbrushes in which the brush head carries out a translatory oscillatory movement and a rotary oscillatory movement or for razors where the shaving head carries out a translatory and a rotary oscillatory movement.

In a method in accordance with the invention for the generation of a translatory oscillatory movement of the rotor of an electric motor, the Lorentz force on the conductors of the coil through which current flows in a permanent magnetic field is utilized for the generation of the translatory oscillatory movement of the rotor.

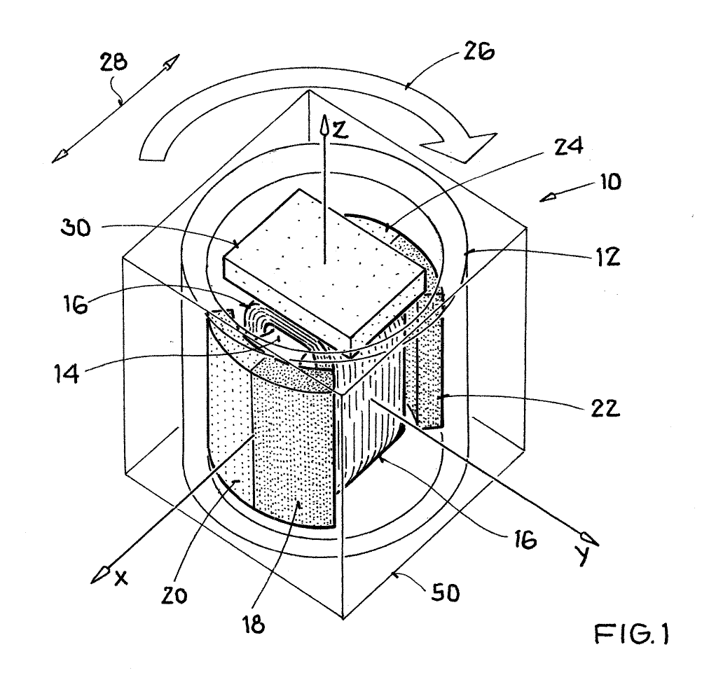

FIG. 1 shows one embodiment of an electric motor 10 for an electric appliance having a rotor 12 which is shown transparent here for the better representability of the other components. A drawing border 50 is shown in FIG. 1 only to illustrate the perspective.

Permanent magnets 18, 20, 22, 24 are fastened inside the rotor and are moved with it, with magnets 18, 20 or 22, 24 disposed next to one another each being magnetized with opposite polarities. The rotor is rotatably supported about the Z axis, which is indicated by the arrow 26. A coil 16 is arranged within the rotor with an iron core 14 located therein as a stator. The coil windings are disposed in planes parallel to the Y-Z plane. In FIG. 1, a permanent magnet 30 called a Lorentz magnet here is arranged above this arrangement, wherein a magnetic field generated by the Lorentz magnet 30 would be parallel to the Z axis if it were not distorted by the influence of the coil 16 or of the permanent magnets 18, 20, 22, 24. The Lorentz magnet 30 is also fixedly connected to the rotor 12. A Lorentz force is generated in the direction of the arrow 28 on the arrangement of coil 16 and stator 14 in a manner still to be described with the help of the additional permanent magnet 30 when current is flowing in the coil. With a fixed coil 16, this means a translatory oscillatory movement of the rotor 12 together with the magnets 18, 20, 22, 24 and the Lorentz magnet 30 in the direction 28.

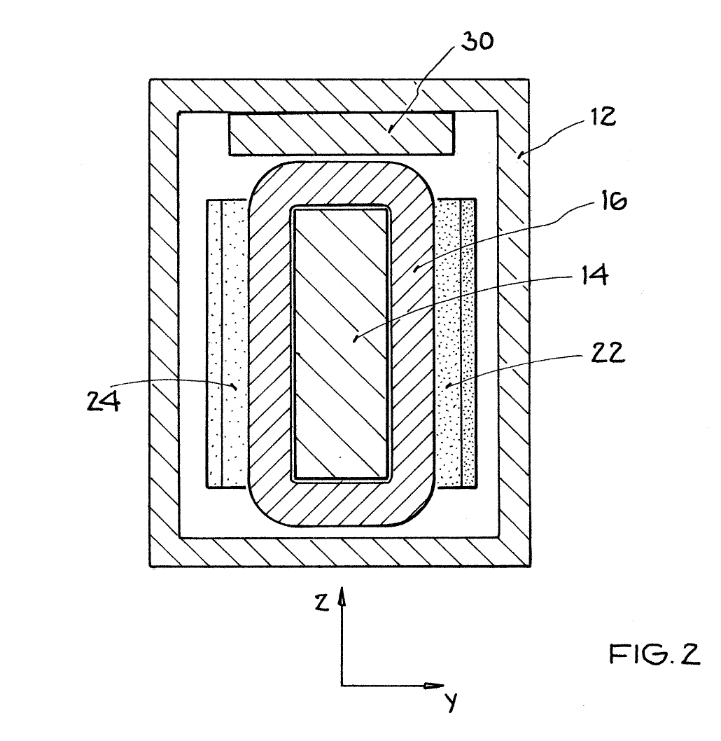

FIG. 2 shows a sectional representation in the Y-Z plane. The translatory oscillatory movement 28 thereby arises as follows. The coil 16 and the iron core 14 act with the permanent magnets 18, 20, 22, 24 as in an electric motor for the generation of a rotary movement when a current is flowing in the coil. For this purpose, a magnetic flux is generated through the coil in the iron core 14. The surrounding permanent magnets 18, 20, 22, 24, and thus the rotor 12, align in accordance with the direction of flux.

In addition to the forces which arise which result in the rotary movement, a Lorentz force is additionally present on the conductor of the coil 16 through which current flows in the direction of the vector product from the magnetic flux and the direction of the conductor through which current flows multiplied by the length of the conductor, through which current flows and which is exposed to the magnetic flux, and by the current. The Lorentz magnet 30 is aligned in the embodiment of FIGS. 1 and 2 such that it generates magnetic flux substantially in the direction of the axis of rotation (Z axis). In this respect, the coil windings of the coil 16 are disposed in the image plane of FIG. 2. In particular in the region of the coil 16 at the top in FIG. 2 and in direct proximity to the Lorentz magnet 30, the conductors of the coil windings through which current flows accordingly extend in the Y direction. If current accordingly flows through the coil 16, a relative force effect arises between the coil and the Lorentz magnet 30 in the x direction. With a fixedly held coil 16, the Lorentz magnet 30 therefore moves together with the rotor 12 in the X direction.

If the rotor 12 rotates continuously, the current direction through the coil changes periodically in the coordinate system of the rotor 12 or of the Lorentz magnet 30 fixedly connected thereto so that a translatory oscillatory movement arises. With a suitable polarity reversal of the current direction for the generation of a rotary oscillatory movement in or opposite to the direction 26, the current direction also changes relative to the magnetic flux generated by the Lorentz magnet so that a translatory oscillatory movement also arises then.

If, for example, the brush head of an electric toothbrush or the shaving head of an electric shaver is connected to the rotor 12, this not only carries out the rotary movement 26 of the rotor 12, but also the translatory movement in the direction 28.

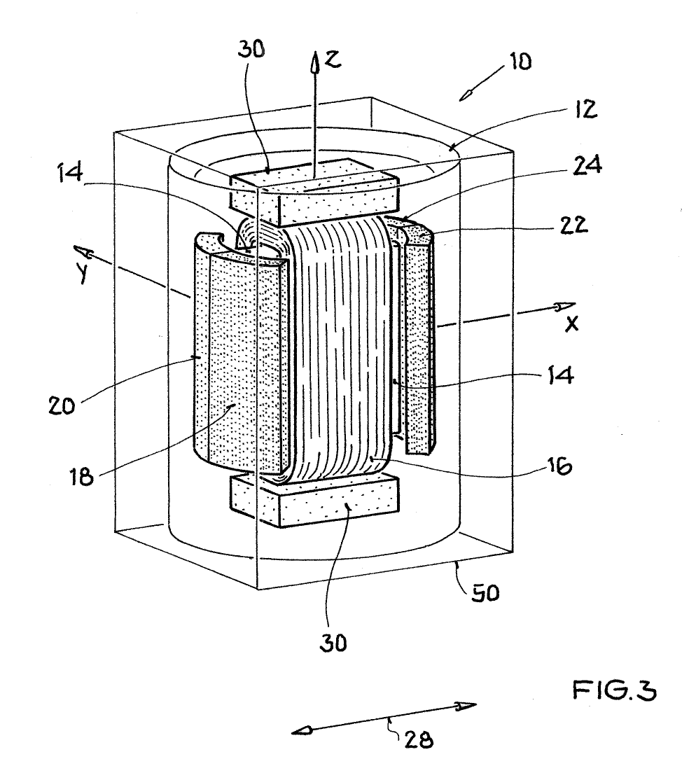

FIG. 3 shows a modified embodiment in which two Lorentz magnets 30 are provided above and beneath the coil 16. The force effect is thereby substantially doubled.

The Lorentz force in arrangements of FIGS. 1 to 3 in particular acts on the conductors through which current flows of the here shorter coil side and which are aligned parallel to the y direction.

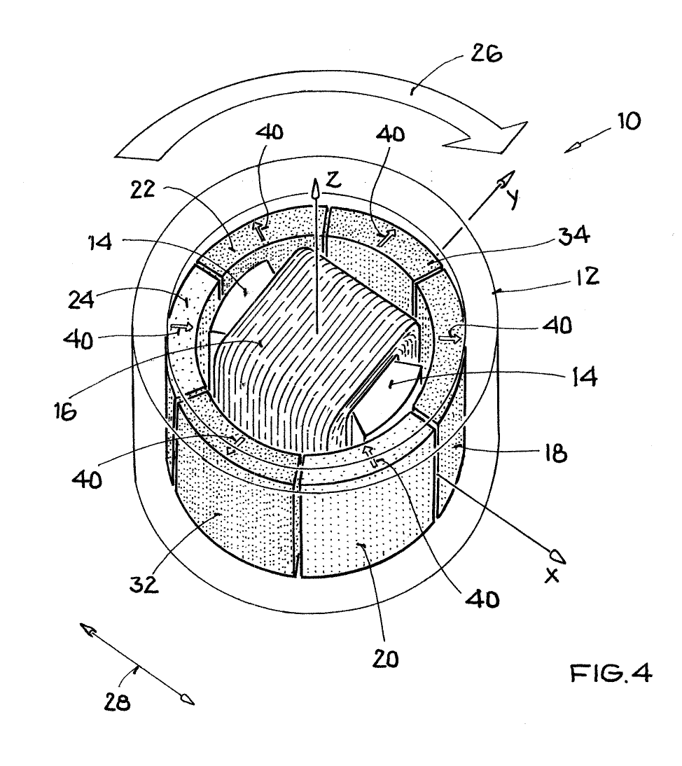

In an embodiment of FIG. 4, magnet segments 32, 34 are arranged as Lorentz magnets between the permanent magnets 18, 20, 22, 24 in addition to the permanent magnets 18, 20, 22, 24 generating the rotary movement. They accordingly generate magnetic flux through the coil 16 in the Y direction. This magnetic flux therefore in particular acts on the here longer coil sections which extend parallel to the Z direction in the representation of FIG. 4.

The magnetic segments 32, 34 in this embodiment have substantially the same polarity as the permanent magnets 18 and 22. Arrows 40 schematically indicate the relative polarity of the respective permanent magnets 18, 20, 22, 24 or of the Lorentz magnets 32, 34, with the arrows indicating the direction from south pole to north pole. If, for example, the south poles are arranged radially inwardly in the magnet segments 32, 34 and the permanent magnets 18, 22, the north poles are radially inwardly arranged in the permanent magnets 20, 24.

In an arrangement of FIG. 4, a Lorentz force is generated on the conductors of the coil 16 through which current flows in the direction X. This is aligned in the direction 28 in accordance with the cross product for the determination of the Lorentz force. With a fixedly held coil 16 or a fixedly held iron core 14, the rotor 12 therefore not only moves rotarily in the direction 26, but also translatorily in the direction 28.

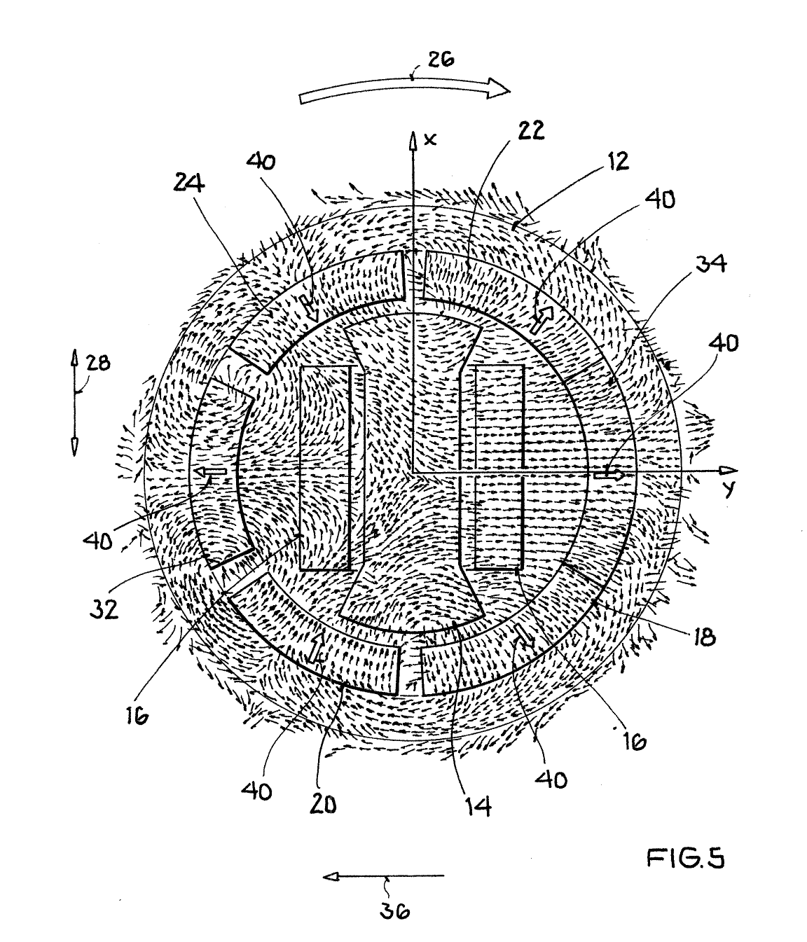

FIG. 5 shows a cross-section through the arrangement of FIG. 4 in the X-Y plane. Additionally, the directions of the magnetic field lines are indicated here which result from the arrangement of the permanent magnets 18, 20, 22, 24 and of the Lorentz magnets 32 and 34. As can be recognized particularly clearly in the representation of FIG. 5, the Lorentz magnet 34 forms part of a larger magnetic element which takes over the function of the permanent magnets 18, 22 and of the Lorentz magnet 34 and whose polarity for all three segments 18, 22, 34 faces in the same direction either radially outwardly or radially inwardly.

Whereas the polarity of the Lorentz magnet 32 faces in the same direction in the radial direction (that is, for example, outwardly when the polarity of the permanent magnets 18, 22 and of the Lorentz magnet 34 is directed outwardly), the polarity of the permanent magnets 20, 24 is oppositely directed in the radial direction.

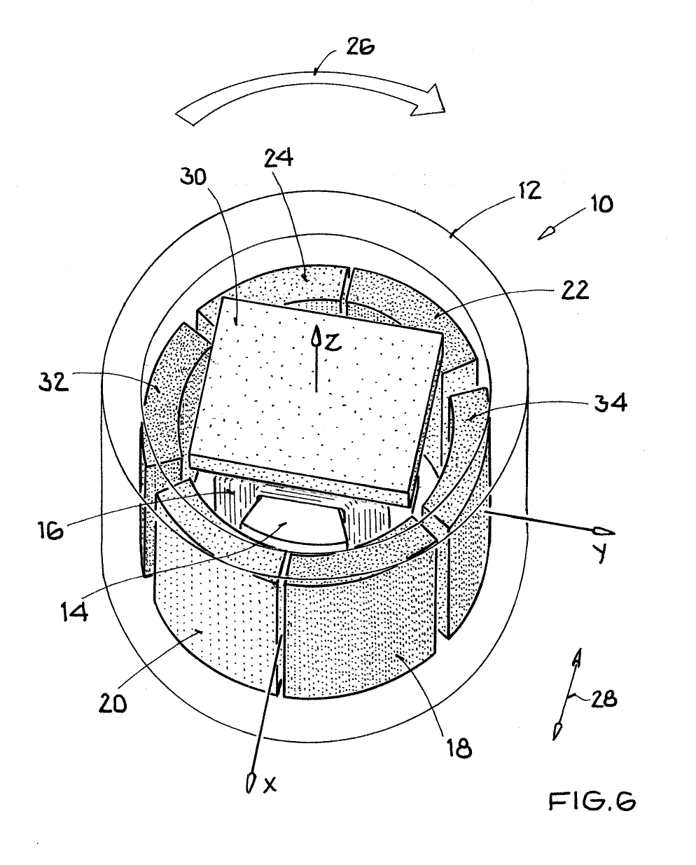

The embodiment of FIG. 6 is a combination of the embodiments of FIG. 1 and FIG. 4. Here, radially arranged Lorentz magnets 32, 34, and an axially arranged Lorentz magnet 30 are provided. A suitable selection of the strength of these magnets allows a flexible setting of the Lorentz force and thus of the translatory force.

In all embodiments, either the translatory oscillatory movement or the rotary oscillatory movement can be excited by a corresponding selection of the frequency of the current fed into the coil. For this purpose, the frequency fed in is selected in accordance with the resonant frequency of the respective oscillatory movement. A selection of a corresponding mixed frequency or irradiation of a plurality of frequencies can be used to set the strength of the oscillatory movements relative to one another.

The embodiments in accordance with the invention reduce the number of the individual parts required for the construction of the drive and enable a compact construction shape of the drive unit. Depending on the construction design of the drive, the achievable torques of the rotary movement and the forces in translatory directions can be set freely. The torques and forces are scaled approximately linearly with the length of the motor and the translatory movement proves to be largely independent of the angular position of the rotary movement. The noise development is lower due to the omission of a transmission for the generation of an additional translatory movement.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An electric motor for an electric appliance, comprising:
a rotor having an axis of rotation;
a stator;
a coil having conductors;
a first magnet arrangement having at least one first permanent magnet which generates a force for the excitation of a rotary movement of the rotor about an axis of rotation by interaction with a magnetic field generated using the coil; and
a second magnet arrangement which includes at least one second permanent magnet which is arranged such that a translatory oscillatory movement of the rotor is effected by a Lorentz force acting in a first field of the second permanent magnet on the conductors of the coil through which current flows.

2. The electric motor of claim 1, wherein the second magnet arrangement is connected with the rotor.

3. The electric motor of claim 1, wherein the at least one second permanent magnet has a second field that is arranged such that it is not influenced by other fields and aligned substantially parallel to the axis of rotation of the rotor.

4. The electric motor of the claim 1, wherein the at least one second permanent magnet is arranged such that the second field is not influenced by other fields and is aligned substantially radially to the axis of rotation of the rotor.

5. The electric motor of claim 4, wherein the first magnet arrangement comprises a plurality of permanent magnets which are arranged concentrically to the axis of rotation and the at least one permanent magnet of the second magnet arrangement is arranged between permanent magnets of the first magnet arrangement in a circumferential direction of a circular shape defined by the concentric arrangement of the permanent magnets of the first magnet arrangement.

6. The electric motor of claim 4, wherein the second magnet arrangement includes at least one additional permanent magnet which is arranged such that it has a third field not influenced by other fields which is aligned substantially parallel to the axis of rotation of the rotor.

7. The electric motor of claim 1, wherein the at least one permanent magnet of the second magnet arrangement is integral with at least one permanent magnet of the first magnet arrangement.

8. An electric motor for an electric appliance, comprising:
a rotor;
a stator;
a coil having conductors; and
a first magnet arrangement having at least one first permanent magnet which, by interaction with a magnetic field generated using the coil, generates a force for the excitation of a rotary movement of the rotor about an axis of rotation;
wherein the first magnet arrangement is arranged such that a translatory oscillatory movement of the rotor is effected by a Lorentz force acting in the magnetic field of the at least one first permanent magnet on the conductors of the coil through which a current flows.

9. The electric motor of claim 8, wherein the at least one first permanent magnet and the coil are arranged such that the at least one first permanent magnet, by interaction with a magnetic field generated using the coil, generates a force for the excitation of a rotary oscillatory movement of the rotor.

10. The electric motor of claim 9, wherein the rotary oscillatory movement and the translatory oscillatory movement have different resonant frequencies.

11. The electric motor of claim 8, wherein the rotor includes the first magnet arrangement and the coil is arranged inside the first magnet arrangement.

13. An electric toothbrush comprising the electric motor of claim 8, wherein the electric toothbrush has a brush head and the electric motor generates a translatory oscillatory movement of the brush head and a rotary movement of the brush head.

14. An electric razor comprising the electric motor of claim 8, wherein the electric razor has a shaving head and the electric motor generates a translatory oscillatory movement of the shaving head and of a rotary movement of the shaving head.

15. A method of providing a translator oscillatory movement in an electric motor, the electric motor having a rotor, a stator, a coil including conductors and a magnetic arrangement including at least one permanent magnet, the method including the steps of:
generating a magnetic field with the coil;
generating a force to rotate the rotor by interacting the at least one permanent magnet with the magnetic field; and
generating a Lorentz force on the conductors of the coil through which current flows to provide a translator oscillatory movement in the rotor.
